(19) United States
(12) Patent Application Publication
(10) Pub. No.: US 2023/0016786 A1
(43) Pub. Date: Jan. 19, 2023

(54) DEVICE AND METHOD FOR GUIDING EVACUATION BY USING LASER

(71) Applicant: DM SYSTEM CO., LTD, Jingeon-eup Namyangju-si, Gyeonggi-do (KR)

(72) Inventor: Myoung-Ho KIM, Opo-eup Gwangju-si (KR)

(73) Assignee: DM SYSTEM CO., LTD, Jingeon-eup Namyangju-si, Gyeonggi-do (KR)

(21) Appl. No.: 17/789,500

(22) PCT Filed: Aug. 3, 2020
(86) PCT No.: PCT/KR2020/010192

§ 371 Date: Jun. 27, 2022

(30) Foreign Application Priority Data
Dec. 26, 2019 (KR) 10-2019-0174639

(51) Int. Cl. G08B 5/30; G08B 5/36; G08B 17/06

(52) U.S. Cl. CPC G08B 5/30; G08B 5/36; G08B 17/06

(57) ABSTRACT

The present invention relates to a device and a method for guiding evacuation by using laser and, specifically, to a device and a method wherein, in the case of fire or power outage, laser beams can be emitted to guide an evacuation direction or an emergency exit position. The present invention may comprise: a laser beam generation module for emitting laser beams; a rotation module coupled to the laser beam generation module so as to rotate the laser beam generation module; and a control module for controlling an operation of at least one of the laser beam generation module and the rotation module, wherein the control module controls at least one of the laser beam generation module and the rotation module on the basis of a driving mode configured by a user.

### TECHNICAL FIELD

The present invention relates to a device and a method for guiding evacuation by using laser, and more particularly, to a device and a method for guiding the evacuation direction or the emergency exit position by projecting laser beams in the case of fire or power outage.

### BACKGROUND ART

In general, it is mandatory to install exit signs for evacuating people toward emergency exits in buildings such as buildings larger than a certain size, commercial facilities, public facilities, subways, and multi-use facilities.

The exit signs are installed on ceilings or bottom surfaces or passage floors, are turned on for a predetermined period of time even when the building's power is temporarily cut off due to fire or power outage to serve to enable people to easily find out the emergency exits, and are configured to have a structure in which guidance marks are printed on a plastic plate and an illumination such as light bulbs and fluorescent lamps are installed on a rear side.

However, since the exit signs usually use fluorescent lamps having low luminous intensity, and accordingly visibility is not ensured in the event of fire filled with smoke, thereby losing the function thereof.

In other words, it is difficult to visually determine the positions of emergency exits and the directions of evacuation, since the conventional exit signs are covered by the concentrated smoke around the ceiling upon the fire.

Therefore, it have frequently occurred that people present in a fire-generated zone fail to refer to the above exit signs for evacuation to evacuation sites, thereby causing lots of casualties.

### DISCLOSURE

### Technical Problem

An object of the present invention is to provide a device and a method for guiding the evacuation direction or the emergency exit position by emitting a laser beam in the case of fire or power outage.

### Technical Solution

In order to achieve the above object, the device according to the present invention includes: a laser beam generation module for projecting a laser beam; a rotation module coupled to the laser beam generation module to rotate the laser beam generation module; and a control module for controlling an operation of at least one of the laser beam generation module and the rotation module, wherein the control module may control at least one of the laser beam generation module and the rotation module, based on an operation mode set by a user.

According to the present invention, the rotation module may include: a driving motor; and a power transmission unit installed between the driving motor and the laser beam generation module to transmit a rotational force of the driving motor to the laser beam generation module.

The present invention may further include a selection switch for setting the driving mode by a manipulation of the user.

The present invention may further include: a sensor unit for sensing a fire or power outage situation, wherein the control module may perform an evacuation guidance function according to the driving mode based on a detection result of the sensor unit.

In order to achieve another object, a method for controlling a device, which guides evacuation by using laser and includes a laser beam generation module for projecting a laser beam, a rotation module coupled to the laser beam generation module to rotate the laser beam generation module, and a control module for controlling an operation of at least one of the laser beam generation module and the rotation module includes: sensing a fire or power outage status; selecting any one of preset driving modes of the laser beam generationmodule and the rotation module, based on a detection result of the fire or power outage; and controlling at least one of the laser beam generation moduleand the rotation module based on the selected driving mode.

According to the present invention, the controlling of the at least one of the laser beam generation module and the rotation module may include: controlling the laser beam generation module so that the laser beam is projected; controlling the rotation module so that the laser beam generation module is rotated from one side to an opposite side; controlling the laser beam generation module so that the laser beam is extinguished; and controlling the rotation module so that the laser beam generation module is rotated from the opposite side to the one side.

According to the present invention, the controlling of the at least one of the laser beam generation module and the rotation module may include: controlling the laser beam generation module so that the laser beam is projected; controlling the rotation module so that the laser beam generation module is rotated from the opposite side to the one side; controlling the laser beam generation module so that the laser beam is extinguished; and controlling the rotation module so that the laser beam generation module is rotated from the one side to the opposite side.

According to the present invention, the controlling of the at least one of the laser beam generation module and the rotation module may include: controlling the laser beam generation module so that the laser beam is projected; and controlling the rotation module so that the laser beam generation module is rotated to both sides.

According to the present invention, the controlling of the at least one of the laser beam generation module and the rotation module may include: controlling the laser beam generation module to turn on and off the laser beam; and controlling the rotation module so that the laser beam is projected to a predetermined position.

### Advantageous Effects

The device and the method for guiding evacuation by using laser according to the present invention are configured to rotate and project the laser beam in various ways such as left, right, or both directions in a projected state, or turn on and off the laser beam, so that the evacuation direction and the emergency exit position can be identified more easily.

### DESCRIPTION OF DRAWINGS

FIGS. 1 and 2 are a perspective view and a block diagram of a device for guiding evacuation by using laser according to one embodiment of the present invention.

FIG. 3 is a perspective view showing a state in which the dome shown in FIG. 1 is separated from a housing.

FIG. 4 is a perspective view showing a state in which the upper housing shown in FIG. 3 is removed.

FIG. 5 is a perspective view of the rotation module shown in FIG. 2.

FIG. 6 is a plan view of the laser beam generation module shown in FIG. 2.

FIG. 7 is a block diagram of the control module shown in FIG. 2.

FIG. 8a is a bottom view of the dome shown in FIG. 1.

FIG. 8b is an enlarged view of the fastening protrusion shown in FIG. 8a.

FIG. 9a is a bottom view of the upper housing shown in FIG. 1.

FIG. 9b is an enlarged view of ‘A’ shown in FIG. 9a.

FIG. 10 is a sectional view showing a fastening relationship between the dome and the upper housing shown in FIG. 1.

FIG. 11 is a view showing a state in which the device for guiding evacuation by using laser shown in FIG. 1 is installed in a passage of a building.

FIGS. 12a and 12b are views showing a driving mode of the device for guiding evacuation by using laser shown in FIG. 1, in which a left-direction evacuation mode and a right-direction evacuation mode are sequentially indicated.

FIGS. 13a and 13b are views showing a driving mode of the device for guiding evacuation by using laser shown in FIG. 1, in which a bi-directional evacuation mode and a forward direction mode are sequentially indicated.

FIG. 14 is a flowchart showing, in time series, a method for guiding evacuation using the device for guiding evacuation by using laser shown in FIG. 1.

FIG. 15 is a flow chart specifying S110 to S130 shown in FIG. 14.

### BEST MODE

### Mode for Invention

Hereinafter, most exemplary embodiments of the present invention will be described in detail with reference to the accompanying drawings in order to enable a person having ordinary skill in the art to easily carry out technical idea of the present invention.

First, when reference numerals are added to elements of each drawing, it will be noted that the same elements are denoted by the same reference numerals as possible even when indicated in different drawings.

In addition, for describing the present invention, the detailed description of the related known configuration or function will be omitted when it possibly makes the subject matter of the present invention unclear.

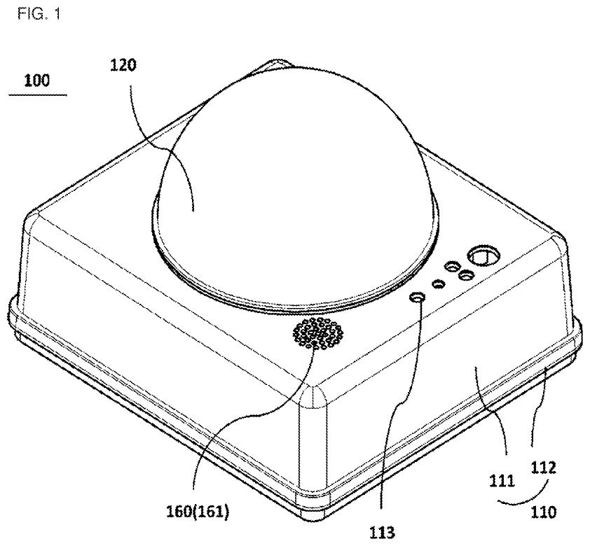

Hereinafter, a device for guiding evacuation by using laser according to one embodiment of the present invention will be described with reference to FIGS. 1 to 13b.

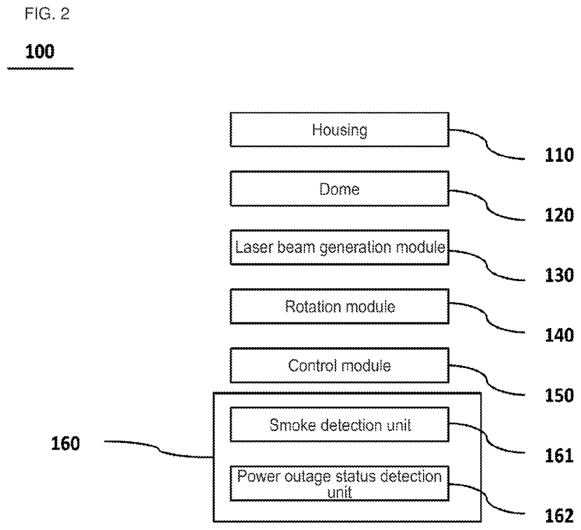

FIGS. 1 and 2 are a perspective view and a block diagram of a device for guiding evacuation by using laser according to one embodiment of the present invention.

Referring to FIGS. 1 and 2, a laser evacuation guidance device 100 includes: a laser beam generation module 130 for projecting a laser beam; a rotation module 140 coupled to the laser beam generation module 130 to rotate the laser beam generation module 130; and a control module 150 for controlling the operation of at least one of the laser beam generation module 130 and the rotation module 140, wherein the control module 150 may control at least one of the laser beam generation module 130 and the rotation module 140 based on an operation mode set by a user.

More specifically, the rotation module 140 is installed inside the housing 110, and the laser beam generation module 130 is disposed inside a dome 120 installed in the housing 110 to continuously project or turn on or off a laser beam for a predetermined period of time so as to guide the evacuation direction or the emergency exit position capable of evacuation.

The housing 110 includes a plate-shaped lower housing 112 installed therein with the rotation module 140, and an upper housing 111 installed to the lower housing 112.

A through-hole 111a corresponding to a diameter of the dome 120 is formed on an upper surface of the upper housing 111, and the dome 120 is coupled to the upper housing 111, so that the laser beam generation module 130 may be disposed inside the dome 120.

The housing 110 may be formed of known materials with a certain rigidity, such as wood, iron, and plastic, and the dome 120 may be formed using a known transparent material such as glass and transparent plastic, so that the laser beam projected from the laser beam generation module 130 may be transmitted.

In addition, the laser evacuation guidance device 100 further includes a sensor unit 160 for sensing a fire or power outage status, wherein the control module 150 may perform an evacuation guidance function according to the driving mode, based on the detection result of the sensor unit 160.

In other words, when the fire or power outage status is detected through the sensor unit 160, the laser evacuation guidance device 100 uses the characteristics of a laser beam, which scatters light in a medium such as smoke and gets brighter so as to guide the evacuation directions or the emergency exit positions, so that people may be safely evacuated even in situations where visibility is not secured.

The laser evacuation guidance device 100, that is, the housing 110 may be installed at a predetermined position. Herein, the predetermined position may correspond to a specific position of a structure, such as a wall or ceiling of a building, or a column installed outdoors, to which the laser evacuation guidance device 100 is installed.

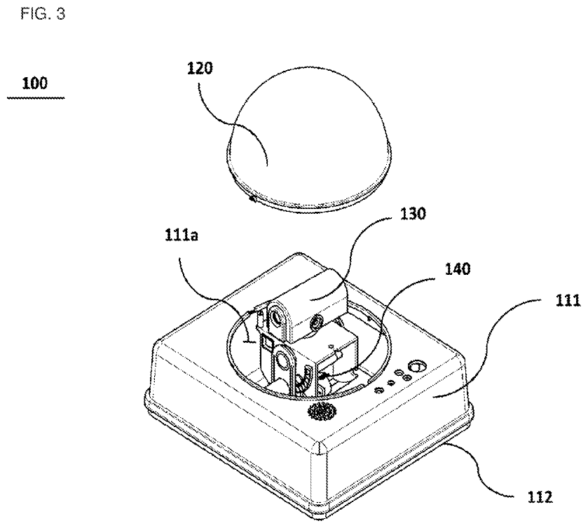

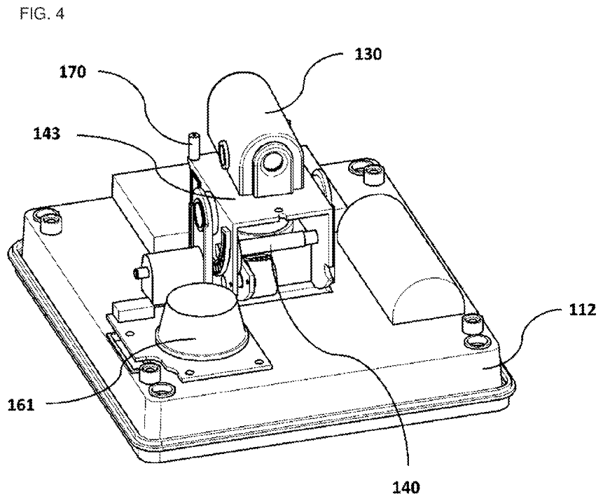

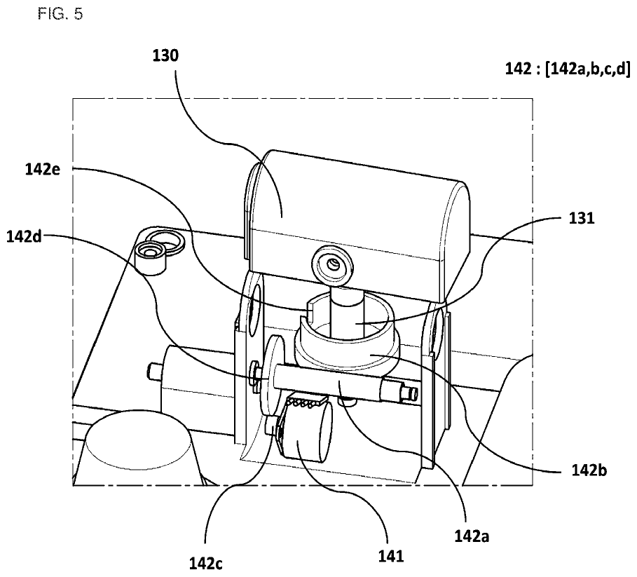

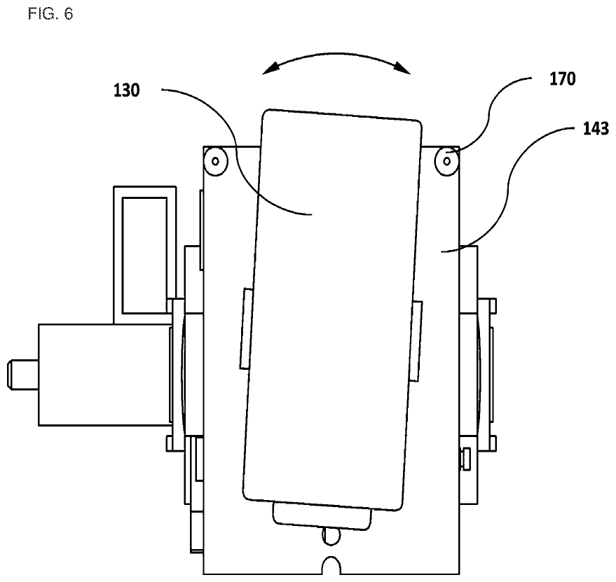

FIG. 4 is a perspective view showing a state in which the upper housing shown in FIG. 3 is removed. FIG. 5 is a perspective view of the rotation module shown in FIG. 2. FIG. 6 is a plan view of the laser beam generation module shown in FIG. 2.

Referring to FIGS. 1 to 5, the rotation module 140 may include a driving motor 141 and a power transmission unit 142 installed between the driving motor 141 and the laser beam generation module 130 to transmit a rotational force of the driving motor 141 to the laser beam generation module 130. The power transmission unit 142 as a first embodiment may be implemented in a wheel-worm gear type, and a wheel gear 142b is installed on a rotation shaft 131 fixed to the laser beam generation module 130 and meshes with a worm gear 142a.

In addition, a main driving gear 142c is installed on a motor shaft of the driving motor 141, and a driven gear 142d meshing with the main driving gear 142c is installed at an end of the worm gear 142a, so that the rotational force of the driving motor 141 may be transmitted to the laser beam generation module 130.

In addition, as a second embodiment of the power transmission unit 142, although not shown in the drawings, the driven gear 142d meshing with the main driving gear 142c may be directly installed on the rotation shaft 131.

In addition, as a third embodiment of the power transmission unit 142, pulleys may be installed on the rotation shaft 131 and the motor shaft of the driving motor 141, respectively, and a belt may be installed on the pulley.

In other words, the rotational force of the driving motor 141 may be transmitted to the laser beam generation module 130 by the power transmission unit 142, so that the laser beam generation module 130 may be rotated.

The sensor unit 160 may include a smoke detection unit 161 and a power outage status detection unit 162 that are installed in the housing 110.

The smoke detection unit 161 serving as a sensor for detecting an occurrence of smoke may be applied with an ionization detection scheme but is not limited thereto, and may also be applied with a photosensitivity scheme using a photosensitization phenomenon in which a light source is opposed to reduce the amount of light of a light-receiving element through absorption and scattering.

The power outage status detection unit 162 serving as a sensor for detecting a state of power supplied to the laser evacuation guidance device 100 may be connected to a power input unit 10 installed outside, including a building, to detect whether the power outage occurs according to the supply state of power.

In addition, a penetration groove 142e is formed on one side of the wheel gear 142b along a circumference of the wheel gear 142b, in which the transmission groove 142e serves as a reference for positioning the laser beam generation module 130 to a zero point position.

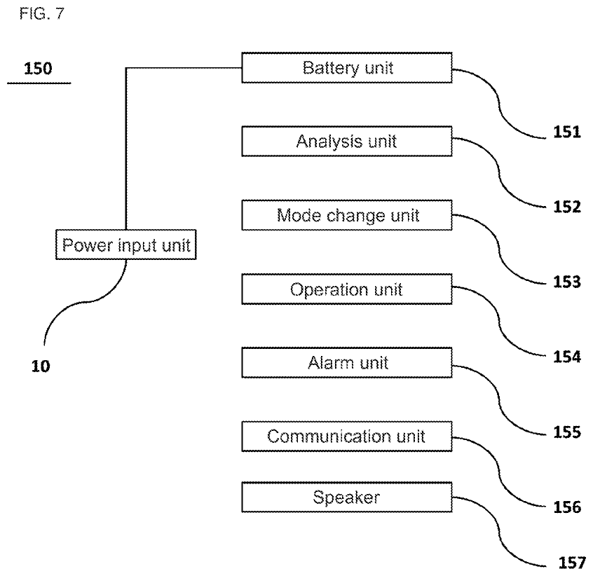

FIG. 7 is a block diagram of the control module shown in FIG. 2. Referring to FIGS. 1 to 7, the control module 150 includes a battery unit 151 for supplying power to the configuration, including the sensor unit 160 or the laser beam generation module 130, of the laser evacuation guidance device 100, and the battery unit 151 may be connected to the power input unit 10 so as to be charged.

In other words, since the power charged in the battery unit 151 may be used even during power outage, the laser evacuation guidance device 100 may perform the evacuation guidance function even during the power outage.

The control module 150 includes an analysis unit 152 for deriving the evacuation direction or the emergency exit position based on the detection of the sensor unit 160, a mode change unit 153 for changing a driving mode of the laser evacuation guidance device 100, and an operation unit 154 for driving the laser beam generation module 130 or the rotation module 140 based on the change of the mode change unit 153.

The positions of emergency exits may be stored in advance based on design of the building, and the analysis unit 152 derives a fire-occurring position based on the detection of the sensor unit 160 and derives the evacuation direction or the emergency exit position based on the derived fire-occurring position.

The control module 150 may further include an alarm unit 155 and a communication unit 156, wherein the alarm unit 155 may generate a warning signal upon the fire or power outage and generate a warning sound through a speaker 157.

The communication unit 156 may perform interoperation between the multiple laser evacuation guidance devices 100, and transmit and receive information on the fire situation, which includes an occurrence of fire or power outage, a position of occurrence, a time of occurrence, a degree of fire, or a type of fire, and the like, to and from other laser evacuation guidance devices 100 disposed nearby.

The communication unit 156 may connect a communication channel with the other laser evacuation guidance devices 100 to transmit and receive the above-described information on the fire situations, and may use various communication schemes such as Wi-Fi, Bluetooth, ultra wide band (UWB), Zigbee, near field communication (NFC), power line communication (PLC), and infrared communication.

In other words, the information on the fire situations may be sequentially transmitted to the laser evacuation guidance devices 100 disposed nearby through the communication unit 156, the analysis unit 152 may derive the evacuation direction or the emergency exit position based on the information, and accordingly, the laser beam generation module 130 or the rotation module 140 may be operated, so that rapid evacuation guidance can be performed.

In addition, the communication unit 156 may be linked to a terminal of a manager or a central server of a firefighting facility, and transmit and show the above-described information on the fire situation or the warning signal, so that a rapid recovery can proceed.

Further, a management server, which can monitor the overall situation of the multiple laser evacuation guidance devices 100 and control the multiple laser evacuation guidance devices 100 as a whole, may be established. At this point, the management server may control the laser evacuation guidance devices 100 based on the information obtained through each communication unit 156 of the multiple laser evacuation guidance devices 100.

In addition, the management server may be configured to store fire occurrence information obtained from the laser evacuation guidance device 100, for example, information such as the ignition point, the moving direction of fire, and the ignition time, so that the driving of the multiple laser evacuation guidance devices 100 may be controlled.

In addition, the communication unit 156 may be linked to a remote controller. When the laser evacuation guidance device is set or inspected, the manager may manually operate the laser evacuation induction device 100 by transmitting an input signal of the remote controller through a remote control receiver 113 (shown in FIG. 1).

According to the laser evacuation guidance device 100, the selection switch may be installed in the mode change unit 153, so that the user may preset the driving of the laser beam generation module 130 or the rotation module 140 for each driving mode.

The laser evacuation guidance device 100 further includes a stopper 170, wherein the stopper 170 is composed of a pair of round bar members so as to be installed on the upper surface of the module housing 143.

More specifically, the stopper 170 is formed in the shape of a protrusion on the upper surface of the module housing 143, and serves to limit a rotation angle of the laser beam generation module 130, so that, when the laser beam generation module 130 is rotated by more than a prescribed angle due to an F/W error or mechanical operation error, the laser beam generation module 130 may be prevented from being deviated from an operating range, and a harness connected to the laser beam generation module 130 may be prevented from being tangled.

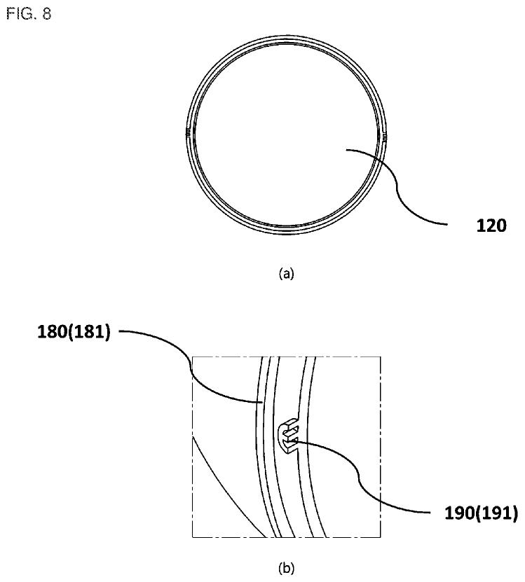

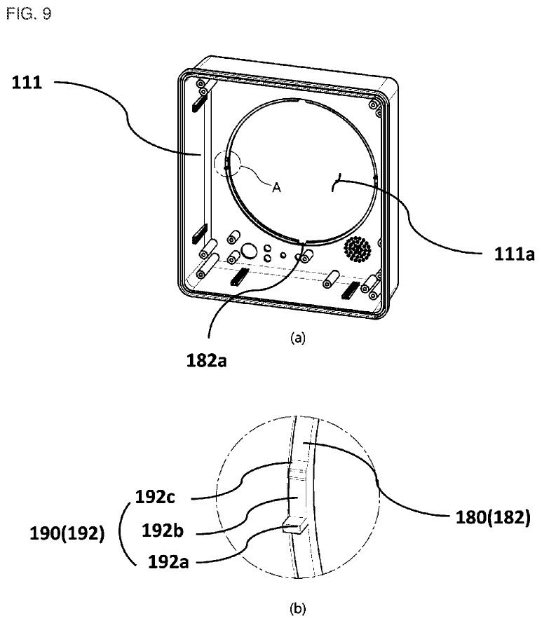

FIG. 8a is a bottom view of the dome shown in FIG. 1, FIG. 8b is an enlarged view of the fastening projection shown in FIG. 8a, and FIG. 9a is a bottom view of the upper housing shown in FIG. 1.

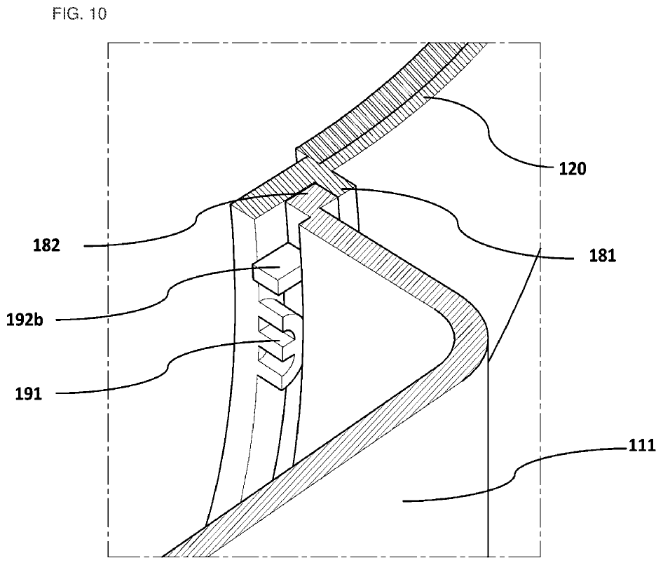

In addition, FIG. 9b is an enlarged view of ‘A’ shown in FIG. 9a, and FIG. 10 is a sectional view showing a fastening relationship between the dome and the upper housing shown in FIG. 1.

Referring to FIGS. 1 to 10, the laser evacuation guidance device 100 further includes a sealing unit 180 and a fastening unit 190, wherein the sealing unit 180 includes a first sealing protrusion 181 spaced apart from an end of the dome 120 at a predetermined interval along a circumference of the dome 120 to protrude from an outer circumferential surface of the dome 120, and a second sealing protrusion 182 protruding from the upper surface of the upper housing 111 along a circumference of the through-hole 111a.

In other words, when the dome 120 is coupled to the upper housing 111, the end of the dome 120 is fitted to the second sealing protrusion 182, and the first and second sealing protrusions 181 and 182 come into close contact with each other, so that the airtightness of the laser evacuation guidance device 100 may be improved.

The fastening unit 190 includes a fastening protrusion 191 protruding from a side of the dome 120 and disposed under the first sealing protrusion 181, and a coupling part 192 to or from which the coupling protrusion 191 is coupled or separated.

The coupling part 192 includes a slide portion 192a protruding by a predetermined length on a lower surface of the second sealing protrusion 182 along a circumference of the second sealing protrusion 182, and a locking portion 192b bent at one end of the slide portion 192a.

The second sealing protrusion 182 is formed with a groove 182a through which the fastening protrusion 191 passes. When the dome 120 is rotated while the fastening protrusion 191 passes through the groove 182a, the fastening protrusion 191 moves along the lower surface of the second sealing protrusion 182 and comes into close contact with the slide portion 192a, and accordingly the movement is restricted by the locking portion 192b.

In other words, the fastening protrusion 191 is disposed on the slide portion 192a, so that the dome 120 is fixed to the upper housing 111, and further, the first and second sealing protrusions 181 and 182 are more firmly engaged with each other.

An inclined portion 192c may be formed at the other end of the slide portion 192a, such that the fastening protrusion 191 is more easily disposed on the slide portion 192a.

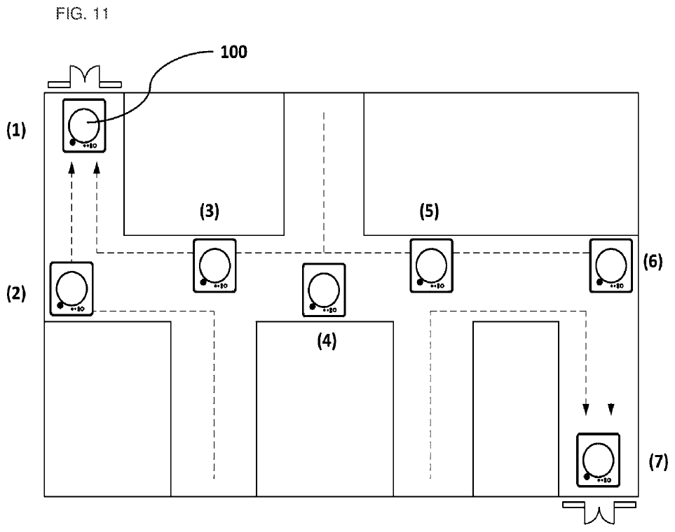

FIG. 11 is a view showing an example of a state in which the device for guiding evacuation by using laser shown in FIG. 1 is installed in a passage of a building.

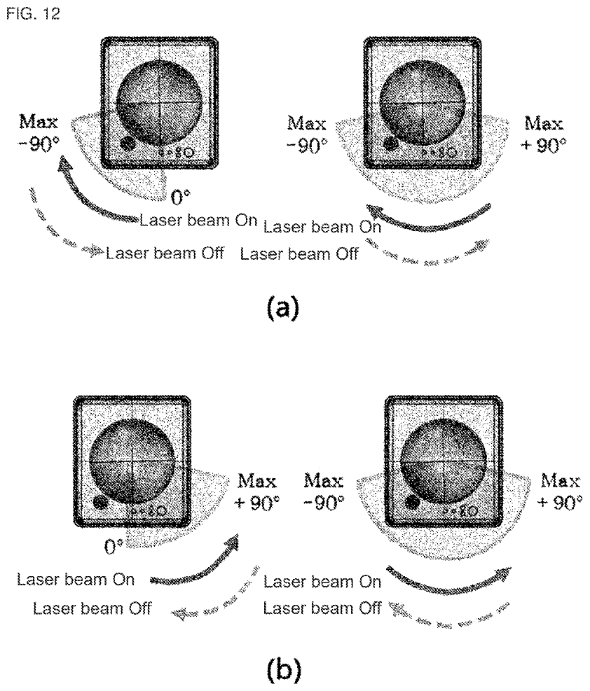

FIGS. 12a and 12b are views showing a driving mode of the device for guiding evacuation by using laser shown in FIG. 1, in which a left-direction evacuation mode and a right-direction evacuation mode are sequentially indicated.

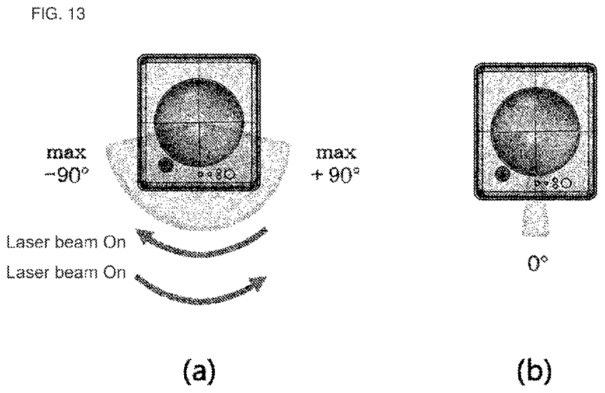

FIGS. 13a and 13b are views showing a driving mode of the device for guiding evacuation by using laser shown in FIG. 1, in which a bi-directional evacuation mode and a forward direction mode are sequentially indicated.

Referring to FIGS. 1 to 13b, the driving mode of the laser evacuation guidance device 100 may include an evacuation mode performed during occurrence of fire or power outage, and a standby mode performed during recovery of the fire or power outage and during normal operations.

The evacuation mode, according to the position of a passage and an emergency exit in a building, may be divided into a first mode as a left-direction evacuation mode, a second mode as a right-direction evacuation mode, a third mode as a bi-direction evacuation mode, and a fourth mode as a forward-direction evacuation mode.

For example, as shown in FIG. 11, the evacuation direction is set toward the emergency exits. The laser evacuation guidance device 100 disposed at position 3 based on the set evacuation direction may perform the left-direction evacuation mode, and the laser evacuation guidance devices 100 disposed at positions 2, 5 and 6 may perform the right-direction evacuation mode.

In addition, the laser evacuation guidance device 100 disposed at position 4 may perform the bi-direction evacuation mode, and the laser evacuation guidance devices 100 disposed at positions 1 and 7 may perform the forward-direction evacuation mode.

Upon the evacuation mode, and when the laser evacuation guidance device is disposed in the passage of the building, the control module 150 may perform a scanning scheme by rotating the laser beam generation module 130 for projecting a laser beam in the evacuation direction.

More specifically, upon the left-direction evacuation mode, the control module 150 controls the laser beam generation module 130 to project the laser beam, controls the rotation module 140 to allow the laser beam generation module 130 to be rotated from one side to the other side, and controls the laser beam generation module 130 to extinguish the laser beam.

In addition, the rotation module 140 is controlled so that the laser beam generation module 130 is rotated from the other side to the one side.

In addition, upon the right-direction evacuation mode, the control module 150 controls the laser beam generation module 130 to project the laser beam, controls the rotation module 140 to allow the laser beam generation module 130 to be rotated from the other side to the one side, and controls the laser beam generation module 130 to extinguish the laser beam.

In addition, the rotation module 140 is controlled so that the laser beam generation module 130 is rotated from the one side to the other side.

In addition, upon the bi-directional evacuation mode, the control module 150 controls the laser beam generation module 130 to project the laser beam, and controls the rotation module 140 to allow the laser beam generation module 130 to be rotated to both sides.

Alternatively, upon the bi-directional evacuation mode, the control module 150 controls the laser beam generation module 130 to project the laser beam, controls the rotation module 140 to allow the laser beam generation module 130 to be rotated from one side to the other side, and controls the laser beam generation module 130 to extinguish the laser beam.

In addition, the control module controls the laser beam generation module 130 to project the laser beam, controls the rotation module 140 to allow the laser beam generation module 130 to be rotated from the other side to the one side, and controls the laser beam generation module 130 to extinguish the laser beam.

The rotation angle of the laser beam generation module 130 may be set by the selection switch included in the mode change unit 153. According to the set value, a half scan, which is rotated by 0 degree to −90 degrees in the left direction and 0 degree to +90 degrees in the right direction, may be performed, or a full scan, which is rotated by −90 degrees to +90 degrees, may be performed.

When the laser evacuation guidance device 100 is disposed at the emergency exit, the control module 150 may be configured such that the position of the emergency exit is recognized by turning on and off the laser beam without rotation of the laser beam generation module 130.

More specifically, upon the forward-direction evacuation mode, the control module 150 controls the laser beam generation module 130 so that the laser beam is turned on and off, and controls the rotation module 140 so that the laser beam is projected to a predetermined position.

In addition, upon the evacuation mode set in the laser evacuation guidance device 100, the user may directly set through the mode change unit 153 while considering the position of the emergency exit in the building, the position of the passage, and the installation position of the laser evacuation guidance device 100. However, the laser evacuation guidance device 100 may also detect the ignition point inside the building and based on this, automatically set the evacuation mode of each laser evacuation guidance device 100.

For example, when fire occurs near position 7 in FIG. 11, the smoke detection unit 161 of the laser evacuation guidance device 100 in position 7 may discover smoke due to the fire first, and transmit fire occurrence information at the position 7 to the other laser evacuation guidance devices 100 through the communication unit 156.

In this case, each laser evacuation guidance device 100 may set the evacuation direction to the direction of the emergency exit near position 1 other than the emergency exit near position 7, so that the casualties of evacuees in the building may be minimized.

In other words, the laser evacuation guidance devices 100 disposed at positions 3, 5 and 6 may automatically set the evacuation mode to perform the left-direction evacuation mode, and the laser evacuation guidance devices 100 disposed at positions 2 and 4 may automatically set the evacuation mode to perform the right-direction evacuation mode.

In addition, as mentioned above, the evacuation mode may be set through communication between the laser evacuation guidance devices 100, and the evacuation mode of each laser evacuation guidance device 100 may also be set through the above-described management server.

Hereinafter, the evacuation guidance method using the laser evacuation guidance device will be described with reference to FIGS. 1 to 15.

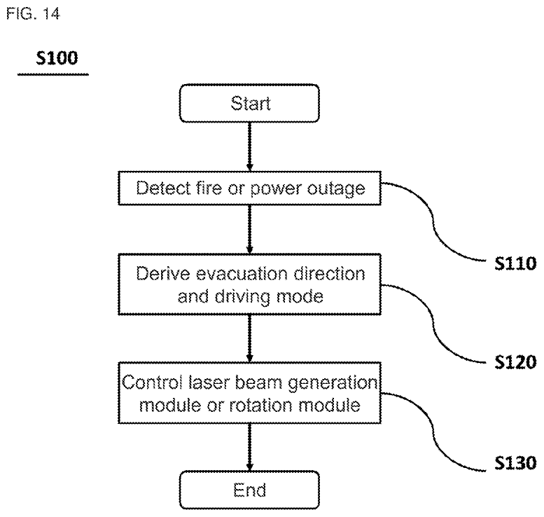

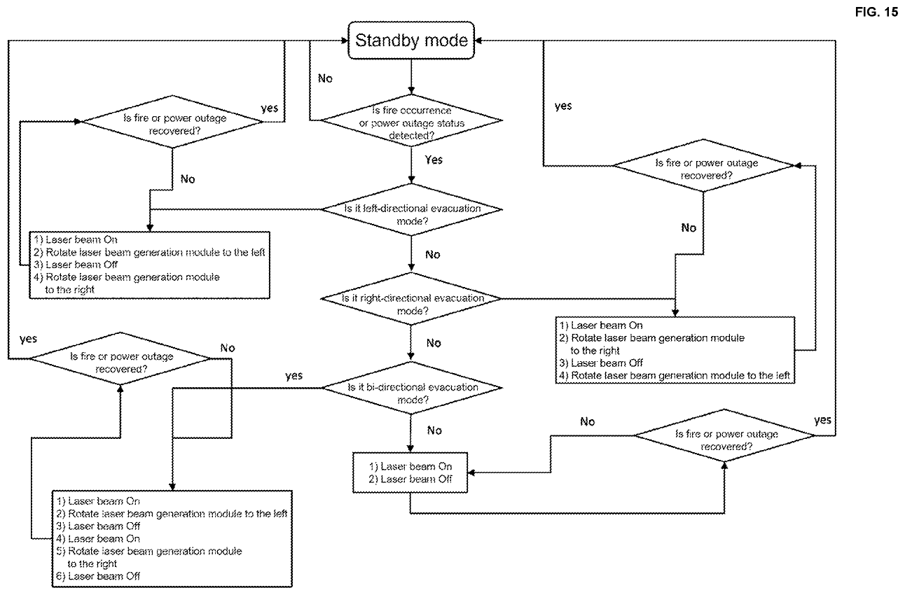

FIG. 14 is a flowchart showing, in time series, a method for guiding evacuation using the device for guiding evacuation by using laser shown in FIG. 1. FIG. 15 is a flow chart specifying S110 to S130 shown in FIG. 14.

First, according to the evacuation guidance method S100, the sensor unit 160 detects a fire or power outage status, the analysis unit 152, upon the fire or power outage status, integrates the preset driving mode and information obtained through communication from the laser evacuation guidance devices 100 disposed nearby, and derives the evacuation direction and the driving mode for enabling the evacuation (S120).

Then, the operation unit 154 controls any one of the laser beam generation module 130 and the rotation module 140 according to the corresponding mode (S130).

The laser beam generation module 130 or the rotation module 140 operates according to the above-described driving mode.

Then, when the fire or power outage status is recovered, the mode change unit 153 changes the mode of the laser evacuation guidance device 100 to a standby mode, and accordingly, the operation unit 154 stops the laser beam generation module 130 and the rotation module 140.

As described above, the device and the method for guiding evacuation by using laser according to one embodiment of the present invention are configured to rotate and project the laser beam in various ways such as left, right, or both directions in a projected state, or turn on and off the laser beam, so that the evacuation direction and the emergency exit position can be identified more easily.

As described above, the best embodiment has been disclosed in the drawings and the specification. The specific terms used herein have been used merely for the purpose of describing the present invention, however, those are not intended to limit the meaning or the scope of the invention as set forth in the claims. Therefore, it will be understood by those skilled in the art that various deformations, modifications and other equivalent embodiments may be applicable based on the above-described embodiments. Therefore, the actual scope of the present invention will be defined by the technical idea of the appended claims.

1. A device for guiding evacuation by using laser, the device comprising:
a laser beam generation module for projecting a laser beam;
a rotation module coupled to the laser beam generation module to rotate the laser beam generation module; and
a control module for controlling an operation of at least one of the laser beam generation module and the rotation module, wherein
the control module controls at least one of the laser beam generation module and the rotation module based on an operation mode set by a user.

2. The device of claim 1, wherein the rotation module includes:
a driving motor; and
a power transmission unit installed between the driving motor and the laser beam generation module to transmit a rotational force of the driving motor to the laser beam generation module.

3. The device of claim 1, further comprising:
a selection switch for setting the driving mode by a manipulation of the user.

4. The device of claim 1, further comprising:
a sensor unit for sensing a fire or power outage situation, wherein
the control module performs an evacuation guidance function according to the driving mode based on a detection result of the sensor unit.

5. A method for controlling a laser evacuation guiding device, which includes a laser beam generation module for projecting a laser beam, a rotation module coupled to the laser beam generation module to rotate the laser beam generation module, and a control module for controlling an operation of at least one of the laser beam generation module and the rotation module,
the method comprising:
sensing a fire or power outage status;
selecting any one of preset driving modes of the laser beam generation module and the rotation module based on a detection result of the fire or power outage; and
controlling at least one of the laser beam generation module and the rotation module based on the selected driving mode.

6. The method of claim 5, wherein the controlling of the at least one of the laser beam generation module and the rotation module includes:
controlling the laser beam generation module so that the laser beam is projected;
controlling the rotation module so that the laser beam generation module is rotated from one side to an opposite side;
controlling the laser beam generation module so that the laser beam is extinguished; and
controlling the rotation module so that the laser beam generation module is rotated from the opposite side to the one side.

7. The method of claim 5, wherein the controlling of the at least one of the laser beam generation module and the rotation module includes:
controlling the laser beam generation module so that the laser beam is projected;
controlling the rotation module so that the laser beam generation module is rotated from the opposite side to the one side;
controlling the laser beam generation module so that the laser beam is extinguished; and
controlling the rotation module so that the laser beam generation module is rotated from one side to an opposite side.

8. The method of claim 5, wherein the controlling of the at least one of the laser beam generation module and the rotation module includes:
controlling the laser beam generation module so that the laser beam is projected; and
controlling the rotation module so that the laser beam generation module is rotated to opposite sides.

9. The method of claim 5, wherein the controlling of the at least one of the laser beam generation module and the rotation module includes:
controlling the laser beam generation module so that the laser beam is turned on and off; and
controlling the rotation module so that the laser beam is projected to a predetermined position.
